(19) United States
(12) Patent Application Publication
(10) Pub. No.: US 2020/0116193 A1
(43) Pub. Date: Apr. 16, 2020

(54) SYSTEMS AND METHODS FOR A SUCTION CUP DEVICE HOLDER

(71) Applicant: Luke FRYDENGER, Boulder, CO (US)

(72) Inventor: Luke FRYDENGER, Boulder, CO (US)

(73) Assignee: AYLO LLC, Boulder, CO (US)

(21) Appl. No.: 16/564,574

(22) Filed: Sep. 9, 2019

Related U.S. Application Data
(63) Continuation-in-part of application No. 16/160,633, filed on Oct. 15, 2018.

(51) Int. Cl. F16B 47/00; H04B 1/3888; F16M 11/08

(52) U.S. Cl. CPC F16B 47/00; F16M 11/08; H04B 1/3888

(57) ABSTRACT

A holder for a mobile device, the mobile device including a raised disc on a face of the device, includes a rotating portion, the rotating portion including a raised portion, the raised portion including a groove shaped to receive the raised disc in a sliding fashion. The holder further includes a base portion interconnected with the rotating portion. The holder further includes a suction cup interconnected with the rotating portion, such that when the rotating portion is rotated, the suction cup is pulled into the base portion.

### CROSS REFERENCE TO RELATED APPLICATIONS

This application is a continuation-in-part of co-pending U.S. application Ser. No. 16/160,633 filed Oct. 15, 2018, which is incorporated herein by reference in its entirety.

### BACKGROUND

Users of smartphones appreciate the ability to mount and hold them in a variety of positions. On common position is one where users may take a video or picture of themselves. Unfortunately, it is often not convenient to mount a phone a flat surface. Therefore, users many times need another individual to assist them in taking a video or picture or alternatively may use an expensive mounting device.

### BRIEF SUMMARY

In one embodiment, a holder for a mobile device, the mobile device including a raised disc on a face of the device, includes a rotating portion, the rotating portion including a raised portion, the raised portion including a groove shaped to receive the raised disc in a sliding fashion. The holder further includes a base portion interconnected with the rotating portion. The holder further includes a suction cup interconnected with the rotating portion, such that when the rotating portion is rotated, the suction cup is pulled into the base portion. In one alternative, the rotating portion includes a first threaded portion and the suction cup includes a second threaded portion, such that the first and second thread portion interface, and when the rotating portion is turned the suction cup is pulled into the base portion. Alternatively, the base portion includes an aperture for a first of the first and second threaded portion to pass through in order to interface with a second of the first and second threaded portion. In another alternative, the base portion is positioned between the rotating portion and the suction cup. Alternatively, the groove and the raised portion have a shape complementary to the raised disc. In another alternative, the raised disc has a circular shape and the raised portion has a shape of no more than half of a circle. Alternatively, raised portion has a receiving side and a closed side, such that when the raised disc is placed in the receiving side the raised disc does not exit the closed side. In another alternative, the closed side is open. Alternatively, the raised disc has a first rectangular shape and the raised portion has a second rectangular shape. In another alternative, the rotating portion includes a cutout area for increased gripping.

In one embodiment, a holder for a mobile device includes a raised disc on a face of a mobile device. The holder further includes a rotating portion, the rotating portion including a raised portion, the raised portion including a groove shaped to receive the raised disc in a sliding fashion. The holder further includes a base portion interconnected with the rotating portion. The holder further includes a suction cup interconnected with the rotating portion, such that when the rotating portion is rotated, the suction cup is pulled into the base portion. In one alternative, the rotating portion includes a first threaded portion and the suction cup includes a second threaded portion, such that the first and second thread portion interface, and when the rotating portion is turned the suction cup is pulled into the base portion. In another alternative, the base portion includes an aperture for a first of the first and second threaded portion to pass through in order to interface with a second of the first and second threaded portion. Alternatively, the base portion is positioned between the rotating portion and the suction cup. In another alternative, the groove and the raised portion have a shape complementary to the raised disc. Alternatively, the raised disc has a circular shape and the raised portion has a shape of no more than half of a circle. In another alternative, the raised portion has a receiving side and a closed side, such that when the raised disc is placed in the receiving side the raised disc does not exit the closed side. Alternatively, the disc includes an adhesive for attaching to the mobile device.

In one embodiment, a method of attaching a mobile device to a flat surface includes providing a holder including a raised disc and a rotating portion, the rotating portion including a raised portion, the raised portion including a groove shaped to receive the raised disc in a sliding fashion. The holder further includes a base portion interconnected with the rotating portion and a suction cup interconnected with the rotating portion, such that when the rotating portion is rotated, the suction cup is pulled into the base portion. The method further includes attaching the raised disc to a face of a mobile device and placing the suction cup on a flat surface. The method further includes rotating the rotating portion to pull the suction cup into the base portion creating a suction and sliding the raised disc into the groove of the rotating portion. In one alternative, the rotating portion includes a first threaded portion and the suction cup includes a second threaded portion, such that the first and second thread portion interface, and when the rotating portion is turned the suction cup is pulled into the base portion.

### BRIEF DESCRIPTION OF THE DRAWINGS

FIG. 1 shows a perspective view one embodiment of a suction cup device holder;

FIG. 2 shows a left side view the suction cup device holder of FIG. 1;

FIG. 3 shows a right side view the suction cup device holder of FIG. 1;

FIG. 4 shows a front side view the suction cup device holder of FIG. 1;

FIG. 5 shows a back side view the suction cup device holder of FIG. 1;

FIG. 6 shows a top view the suction cup device holder of FIG. 1;

FIG. 7 shows a bottom side view the suction cup device holder of FIG. 1;

FIG. 8 shows one embodiment of a suction cup device holder;

FIG. 9 shows one embodiment of a suction cup hanging device;

FIGS. 10-17 show additional assembled views the suction cup holder of FIG. 9;

FIGS. 18-25 show additional assembled views of the suction cup holder of FIG. 8.

### DETAILED DESCRIPTION

Certain terminology is used herein for convenience only and is not to be taken as a limitation on the embodiments of the systems and methods for a suction cup device holder. Essentially in many embodiments, the suction cup holder includes a suction cup that is actuated by turning a contoured tensioning device, that pulls on the suction cup, causing it to stick. Additionally, the contoured tensioning device includes a curved receiver for receiving a disk that may be attached to the back of a device. The receiver is located on the tensioning device portion of the holder. The receiver includes a lip for receiving and retaining a disk. The curved receiver is essentially shaped to receive a disk that is slightly raised off of the back of a device (such as a phone). In many embodiment, this is a portion of a circle, such that opening of the circle is greater than the diameter of the disk to be received.

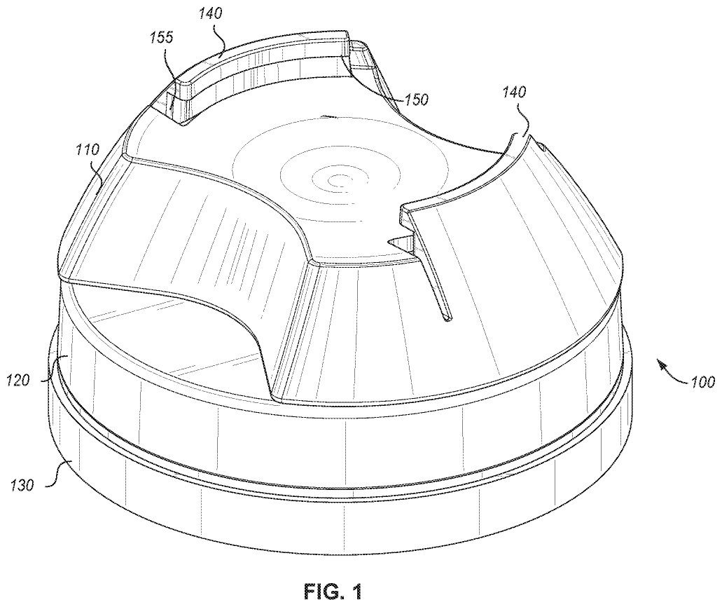

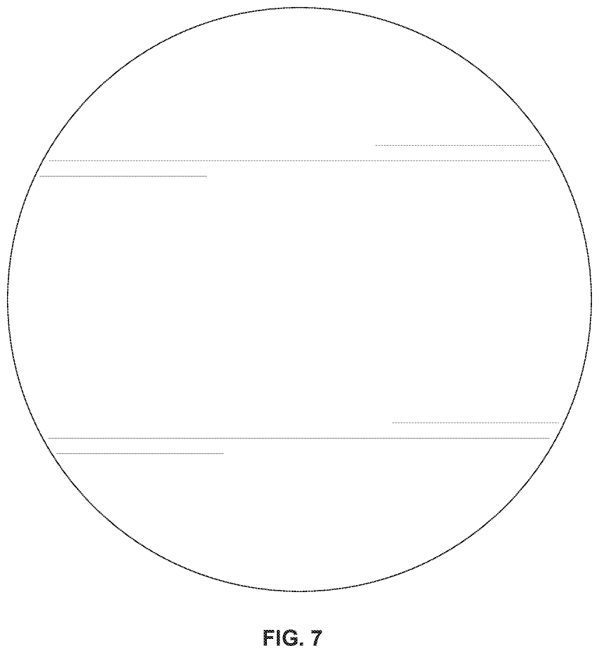

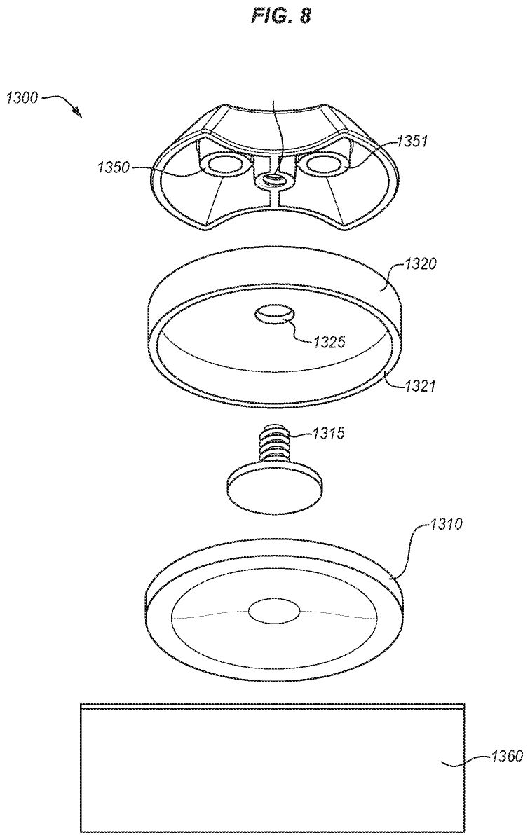

FIG. 1 shows one embodiment of a suction cup device holder 100. In this embodiment, the configuration is advantageous, as it can operate to attach on a flat surface in a horizontal position. This provides a useful feature to the user, such that the device may be simply mounted on a mirror or other smooth surface capable of receiving a suction. Holder 100 includes a rotating portion 110. This portion is contoured to provide for easy finger placement. In the embodiment shown, the form of rotating portion 110 is of a narrowing conical solid with the pointed end cut off and flattened. Additionally, the conical solid has arced cutouts (or contours) to provide for ease of rotation by the hand of a user. Rotating portion 110 is interconnected with base 120. Base 120 is generally a cylindrical solid. Under base 130 is suction cup 130. The arrangement is functionally similar to that shown in FIG. 8. In fact, an exploded view of holder 110 showing a bottom perspective, is essentially the same as that shown in FIG. 8. In other words, rotating portion 110 mates with a screw portion (not shown), in order to pull suction cup 130 up towards base 120 as rotating portion 110 is turned. This creates a suction, causing the device to stick to a smooth, flat surface.

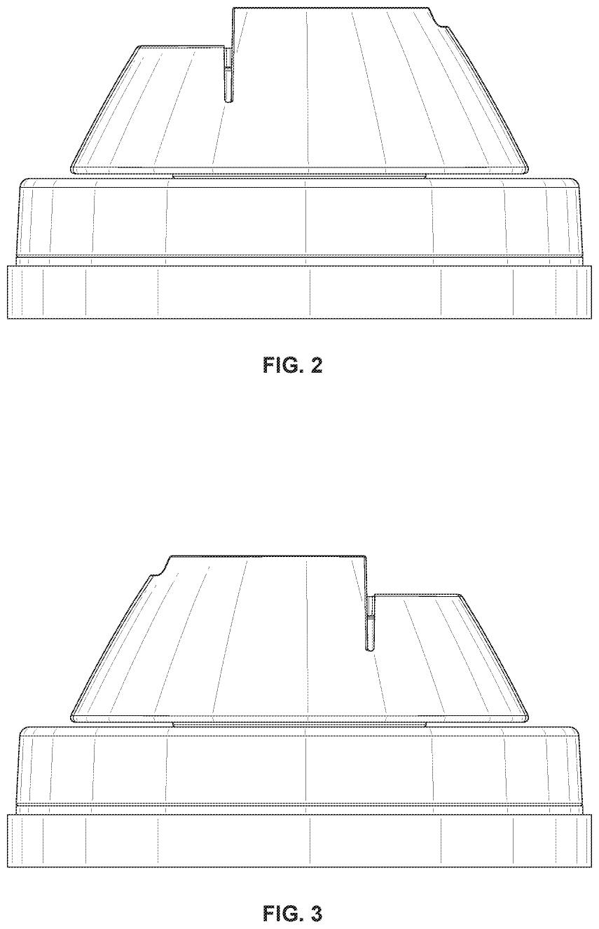

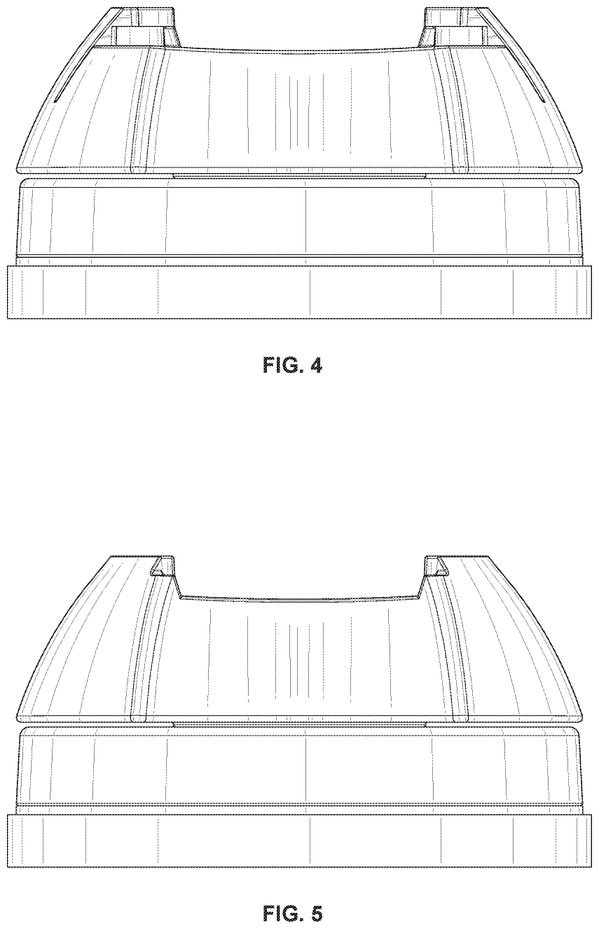

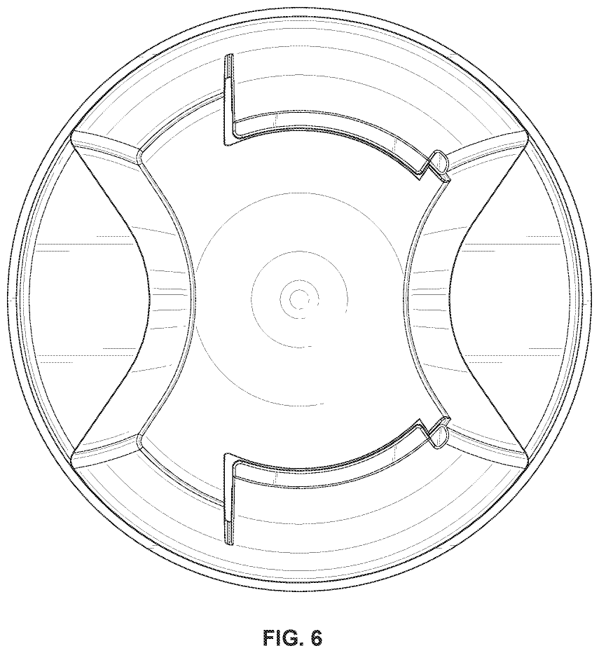

Additionally, as shown in FIG. 1, rotating portion 110 includes a circular ridge 140 that includes a groove 150. This ridge 140 is on both sides of rotating portion 110. In the embodiment show, the ridge is shaped to receive an elevated disk that may be adhered to the back of a mobile device. The entry at the top portion 155 of the ridges 140 to groove 150 is typically wide enough to receive the elevated disk portion. In some embodiments, the entry 155 is approximately the diameter of the disk. Since the ridge is shaped to follow the shape of the elevated disk portion, the top portion 155 may begin at a shape that is the diameter of the disk or less. In alternatives, the shape of the ridges 140 may be a complete half circle. In other alternatives, it may have a square shape or other shape. The point is that the ridges 140 follow that shape of the disk that may be affixed to a device via adhesive (or other attachment method, magnetism, Velcro, etc.) such that the disk may be slide into the grooves of the ridges. Therefore, in operation, the holder is placed on a flat surface, such as a mirror, and the rotating portion 110 is rotated to pull the suction cup 130 up into the base 120, therefore creating suction. A device that includes a disk may then be slid into the holster created by the ridges. FIGS. 2-7 show alternative views of holder 100.

FIG. 8 shows one embodiment of a suction cup holder 1300 for an electronic device, such as a smartphone. Suction cup holder 1300 include a suction cup 1310, a suction frame 1320, and a suction tensioning device 1330. Suction tensioning device 1330 in many embodiments also includes a magnet for attaching to a plate 1360 that is attached via adhesive (an adhesive back) to the electronic device or a case holding the electronic device. Other means of attachment to the electronic device are possible for plate 1360 such as intermediate holders or attachment mechanisms. In the embodiment shown, two magnets 1340, 1341 are used in suction tensioning device 1330. In operation, suction tensioning device 1330 has a first threaded piece 1315 that interfaces with a second threaded area 1340 on suction cup 1310. As the suction cup 1310 screws into the suction tensioning device 1330, via interaction between the first threaded piece 1315 and the second threaded area 1340, the middle portion of the suction cup is pulled up into the suction frame 1320, while the edge of the suction cup 1310 is kept in place by the edge of the suction frame 1320. As shown in the pictures, the first threaded piece 1315 includes a stop end that fits through the aperture in the suction cup 1310 to hold it in place and then screws into second threaded area 1340. In this way, when the device is on a surface, the screwing causes the suction cup 1310 to apply suction. Suction tensioning device may include a high friction outer surface to increase the stability of the attachment of the plate to the suction cup tensioning device. Additionally, magnets 1350, 1351 provide for attachment of plate 1360. The usage of two magnets in some embodiments is thought to be advantageous because it prevents the mobile device from rotating when plate 1360 is attached to magnets 1350, 1351. In such a scenario, the plate is shaped such that it prevents the rotation and fit on the two magnets. As shown, plate 1360 may have a rectangular shape. Other shapes providing a long axis to contact may be used. A single magnet may be used in some embodiments, however, the mobile device attached to the plate may not be as stable in such embodiments, and may rotate. Using the suction cup holder 1300, the phone or other electronic device may be mounted on a surface. Additionally, the suction cup holder 1300 may be used anywhere that it can create suction.

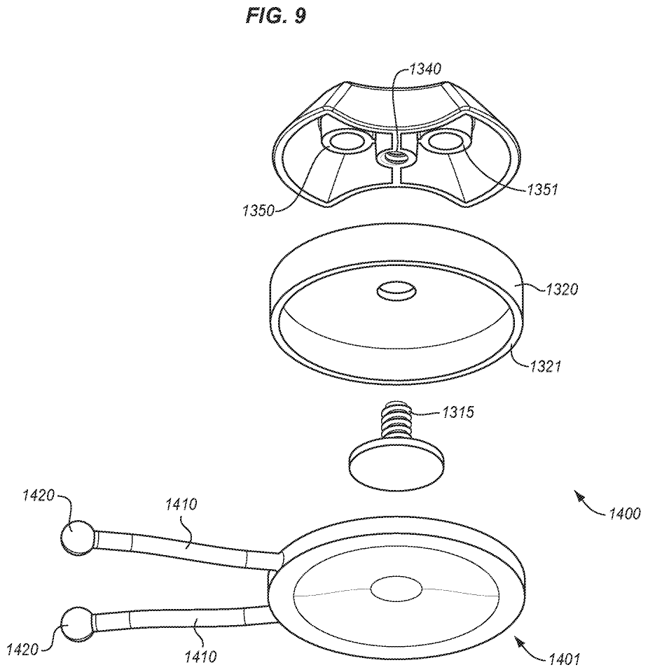

Any alternative embodiment of suction cup holder 1400 is show in FIG. 9. In this embodiment, suction cup 1401 is somewhat different, in that it includes two hangers 1410 having knobbed ends 1420 that fit into apertures in any device in order to hang the device. In this way, various devices may be hung from a flat surface.

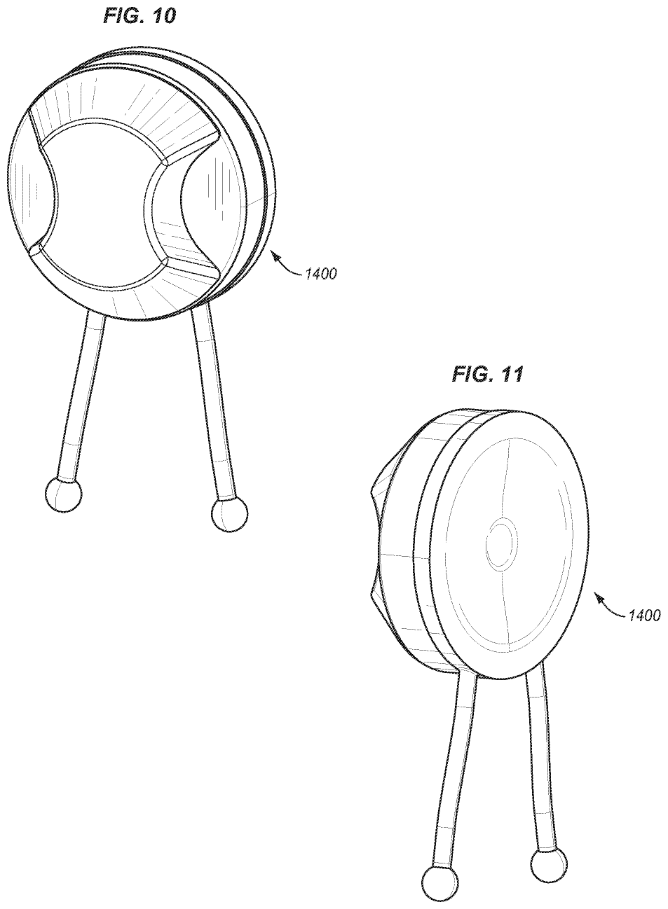

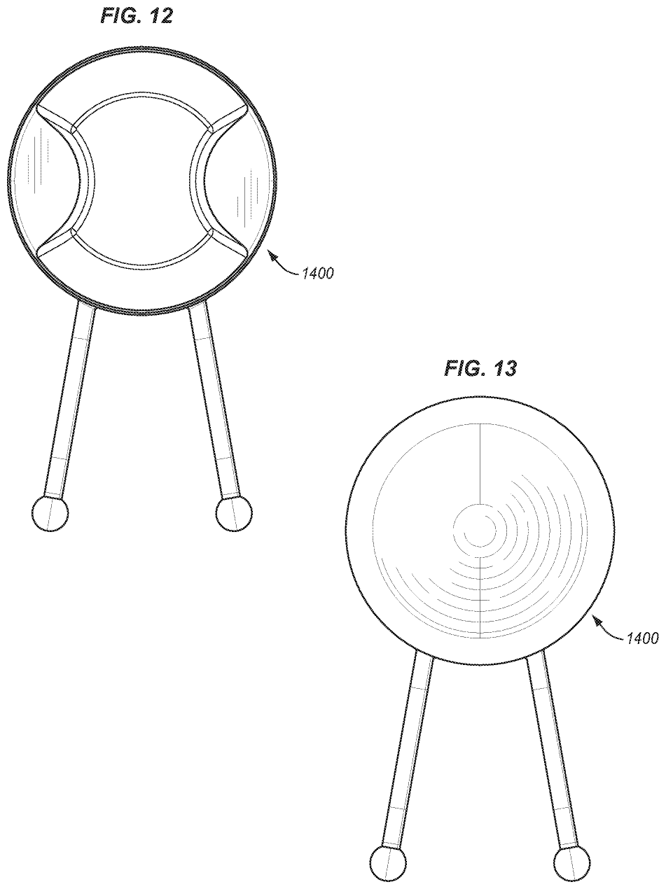

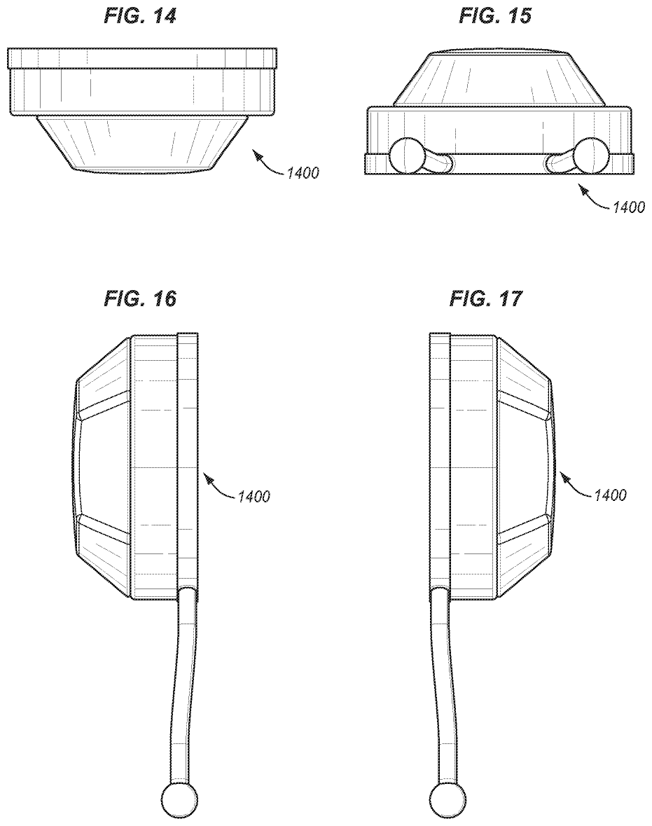

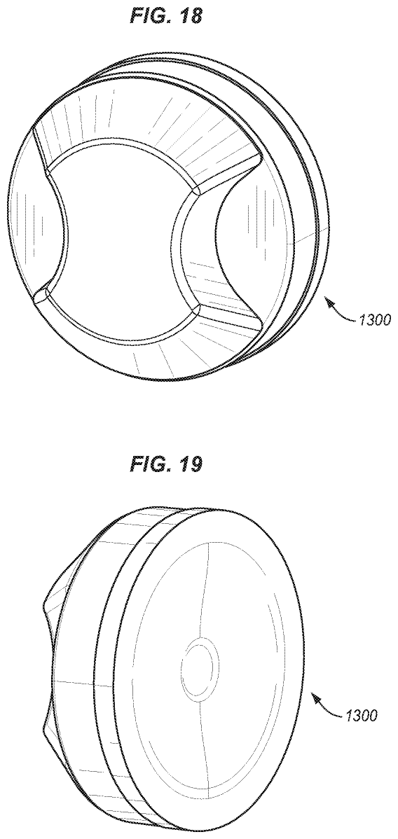

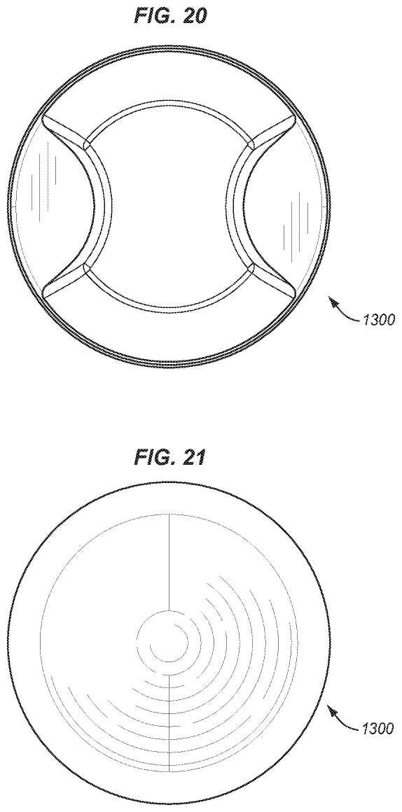

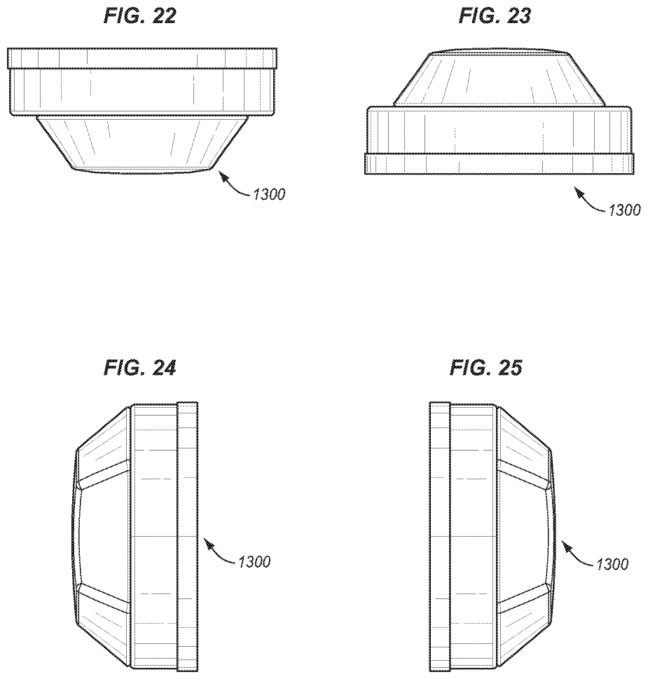

FIGS. 10-17 show additional assembled views suction cup holder 1400. FIGS. 18-25 show additional assembled views of suction cup holder 1300.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A holder for a mobile device, the mobile device including a raised disc on a face of the device, the holder comprising:
a rotating portion, the rotating portion including a raised portion, the raised portion including a groove shaped to receive the raised disc in a sliding fashion;
a base portion interconnected with the rotating portion;
a suction cup interconnected with the rotating portion, such that when the rotating portion is rotated, the suction cup is pulled into the base portion.

2. The holder of claim 1, wherein the rotating portion includes a first threaded portion and the suction cup includes a second threaded portion, such that the first and second thread portion interface, and when the rotating portion is turned the suction cup is pulled into the base portion.

3. The holder of claim 2, wherein the base portion includes an aperture for a first of the first and second threaded portion to pass through in order to interface with a second of the first and second threaded portion.

4. The holder of claim 3, wherein the base portion is positioned between the rotating portion and the suction cup.

5. The holder of claim 4, wherein the groove and the raised portion have a shape complementary to the raised disc.

6. The holder of claim 5, wherein the raised disc has a circular shape and the raised portion has a shape of no more than half of a circle.

7. The holder of claim 6, wherein the raised portion has a receiving side and a closed side, such that when the raised disc is placed in the receiving side the raised disc does not exit the closed side.

8. The holder of claim 7, wherein the closed side is open.

9. The holder of claim 5, wherein the raised disc has a first rectangular shape and the raised portion has a second rectangular shape.

10. The holder of claim 6, wherein the rotating portion includes a cutout area for increased gripping.

11. A holder for a mobile device, comprising:
a raised disc on a face of a mobile device;
a rotating portion, the rotating portion including a raised portion, the raised portion including a groove shaped to receive the raised disc in a sliding fashion;
a base portion interconnected with the rotating portion;
a suction cup interconnected with the rotating portion, such that when the rotating portion is rotated, the suction cup is pulled into the base portion.

12. The holder of claim 11, wherein the rotating portion includes a first threaded portion and the suction cup includes a second threaded portion, such that the first and second thread portion interface, and when the rotating portion is turned the suction cup is pulled into the base portion.

13. The holder of claim 12, wherein the base portion includes an aperture for a first of the first and second threaded portion to pass through in order to interface with a second of the first and second threaded portion.

14. The holder of claim 13, wherein the base portion is positioned between the rotating portion and the suction cup.

15. The holder of claim 14, wherein the groove and the raised portion have a shape complementary to the raised disc.

16. The holder of claim 15, wherein the raised disc has a circular shape and the raised portion has a shape of no more than half of a circle.

17. The holder of claim 16, wherein the raised portion has a receiving side and a closed side, such that when the raised disc is placed in the receiving side the raised disc does not exit the closed side.

18. The holder of claim 11, wherein the disc includes an adhesive for attaching to the mobile device.

19. A method of attaching a mobile device to a flat surface, the method comprising:
providing a holder including:
a raised disc;
a rotating portion, the rotating portion including a raised portion, the raised portion including a groove shaped to receive the raised disc in a sliding fashion;
a base portion interconnected with the rotating portion;
a suction cup interconnected with the rotating portion, such that when the rotating portion is rotated, the suction cup is pulled into the base portion;
attaching the raised disc to a face of a mobile device;
placing the suction cup on a flat surface;
rotating the rotating portion to pull the suction cup into the base portion creating a suction;
sliding the raised disc into the groove of the rotating portion.

20. The method of claim 19 wherein the rotating portion includes a first threaded portion and the suction cup includes a second threaded portion, such that the first and second thread portion interface, and when the rotating portion is turned the suction cup is pulled into the base portion.
